(19) United States
(12) Patent Application Publication
(10) Pub. No.: US 2019/0358725 A1
(43) Pub. Date: Nov. 28, 2019

(54) SINGLE-SIDED SUBMERGED ARC WELDING METHOD AND SINGLE-SIDED SUBMERGED ARC WELDING DEVICE

(71) Applicant: Kabushiki Kaisha Kobe Seiko Sho (Kobe Steel, Ltd.), Kobe-shi (JP)

(72) Inventors: Hiroyoshi YOKOTA, Kanagawa (JP); Masaharu KOMURA, Kanagawa (JP); Shigeru KIHATA, Kanagawa (JP); Daisuke SUGIYAMA, Kanagawa (JP); Takuya YASUHARA, Kanagawa (JP)

(73) Assignee: Kabushiki Kaisha Kobe Seiko Sho (Kobe Steel, Ltd.), Kobe-shi (JP)

(21) Appl. No.: 16/478,253

(22) PCT Filed: Jan. 16, 2018
(86) PCT No.: PCT/JP2018/001075

§ 371 Date: Jul. 16, 2019

(30) Foreign Application Priority Data
Jan. 17, 2017 (JP) 2017-005871

(51) Int. Cl. B23K 9/095; B23K 9/18; B23K 37/06

(52) U.S. Cl. CPC B23K 9/095; B23K 37/06; B23K 9/18

(57) ABSTRACT

A one-side submerged arc welding method includes joining two steel plates butted to each other by submerged arc welding from one side using a plurality of electrodes. During the submerged arc welding, at least one of the electrode distances between adjacent electrodes in a terminal end region of the steel plates is changed.

### TECHNICAL FIELD

The present invention relates to a one-side submerged arc welding method and a one-side submerged arc welding device.

### BACKGROUND ART

One-side submerged arc welding is a highly efficient welding method applied to a wide range of fields, mainly shipbuilding as plate joint welding. On the other hand, in the one-side submerged arc welding, cracks may occur at a joint terminal end portion, and various proposals have been made as its preventive measure.

For example, Patent Literature 1 describes a technique of preventing cracks at an automatically welded terminal end by using a stepped sealing cascade bead in a plurality of layers from a joint terminal end to start end of a welded joint terminal end portion.

Patent Literature 2 discloses a multi-electrode submerged arc welding method capable of obtaining a good welded joint for a wide range of joint thickness by defining a groove shape of a butt portion, a current value of each electrode, and the like.

### CITATION LIST

### Patent Literature

Patent Literature 1: JP-A-H08-99177

Patent Literature 2: JP-A-2007-268551

### SUMMARY OF INVENTION

### Technical Problem

In the technique using the sealing cascade bead in Patent Literature 1, prevention of cracks is achieved by preventing deformation of the welded joint terminal end portion with the sealing cascade bead. However, since a penetration bead is not formed at the portion where the sealing cascade bead is formed, reworking is necessary after the welding. In addition, since it is necessary to form the sealing cascade bead in advance, there is a problem that the number of welding steps increases, and there is room for improvement.

Further, in the multi-electrode submerged arc welding method described in Patent Literature 2, the setting of the welding conditions depending on a specific welding speed is not considered, and a better welding quality is required.

The present invention has been made in view of the above problems, and an object thereof is to provide a one-side submerged arc welding method and a one-side submerged arc welding device, which can be applied to steel plates of a wide range of thickness, can prevent rotational deformation, can prevent cracks of the weld metal at the joint terminal end portion, and can avoid reworking after the welding.

### Solution to Problem

The above object can be achieved by the following constitutions.

The present invention relates to a one-side submerged arc welding method, including joining two steel plates butted each other by submerged arc welding from one side using a plurality of electrodes,

wherein during the submerged arc welding, at least one of electrode distances between adjacent electrodes in a terminal end region of the steel plates is changed.

In addition, in the above method, it is preferred that the electrode distance in the terminal end region is shorter than an electrode distance in a region in front of the terminal end region.

In addition, in the above method, it is preferred that the plurality of electrodes include a first electrode, a second electrode and a third electrode, an electrode distance between the first electrode and the second electrode is changed in a range of 10 mm to 250 mm, and an electrode distance between the second electrode and the third electrode is changed in a range of 10 mm to 250 mm.

In addition, in the above method, it is preferred that the plurality of electrodes include a first electrode, a second electrode, a third electrode and a fourth electrode, an electrode distance between the first electrode and the second electrode is changed in a range of 10 mm to 250 mm, an electrode distance between the second electrode and the third electrode is changed in a range of 10 mm to 250 mm, and an electrode distance between the third electrode and the fourth electrode is changed in a range of 10 mm to 250 mm.

In addition, in the above method, it is preferred that welding in the terminal end region is performed at a welding speed which is equal to or less than 75% of a welding speed in a region in front of the terminal end region.

In addition, in the above method, it is preferred that:

the submerged arc welding is performed in a state where one end edge of two tab plates has been welded to a terminal end of each of the steel plates,

the following relationship between a thickness of the steel plate and a thickness of the tab plate is satisfied: t2>t1, wherein t1 is the thickness of the steel plate and t2 is the thickness of the tab plate,

a width B1 of the two steel plates satisfies the following relationship: B1≥300 mm,

a width B2 of the two tab plates satisfies the following relationships: B2≥10×t1 and 100 mm≤B2≤2000 mm,

a groove of the steel plate and a groove of the tab plate, which are formed by abutting the two steel plates and the two tab plates, respectively, have the same groove shape, and

tack welding of the groove of the steel plate and the groove of the tab plate is performed from at least a terminal end portion side of the steel plate to one end portion side of the tab plate.

The present invention relates to a one-side submerged arc welding device for joining two steel plates butted each other by submerged arc welding from one side, the one-side submerged arc welding device including:

a welding unit which includes a plurality of electrodes and a plurality of power sources which supplies power to the plurality of electrodes, and is movable in a specified direction so as to perform welding from a start end to a terminal end of each of the steel plates by the plurality of electrodes;

a drive mechanism which is disposed in the welding unit and is capable of moving at least one of the plurality of electrodes in an advancing and retracting direction with respect to the welding unit; and

a control unit which controls the drive mechanism to change at least one of electrode distances between adjacent electrodes in a terminal end region of the steel plate during the submerged arc welding.

### Advantageous Effects of Invention

In the one-side submerged arc welding method of the present invention, during the submerged arc welding, at least one of the electrode distances between adjacent electrodes in the terminal end region of the steel plates is changed. Accordingly, since the penetration shape and strain rate in the terminal end portion region are controlled, the techniques of the present invention can be applied to steel plates of a wide range of thickness, can prevent rotational deformation, can prevent cracks of the weld metal at the joint terminal end portion, and can avoid reworking after the welding.

In the one-side submerged arc welding device of the present invention, the control unit controls the drive mechanism so as to change at least one of the electrode distances between adjacent electrodes in the terminal end region of the steel plates during the submerged arc welding. Accordingly, since the penetration shape and strain rate in the terminal end portion region are controlled, the techniques of the present invention can be applied to steel plates of a wide range of thickness, can prevent rotational deformation, can prevent cracks of the weld metal at the joint terminal end portion, and can avoid reworking after the welding.

### BRIEF DESCRIPTION OF DRAWINGS

FIG. 1 is a schematic diagram of a welding device to which a one-side submerged arc welding method of the present invention is applied.

FIG. 2 is a plan view of a steel plate to be welded by the one-side submerged arc welding method of the present invention.

FIG. 3 is a schematic explanatory diagram of the vicinity of a steel plate which shows a state when the one-side submerged arc welding is performed.

FIG. 4 is a schematic explanatory diagram of the vicinity of a steel plate which shows a state when the one-side submerged arc welding is performed.

FIG. 5A is a schematic diagram showing a state where an electrode distance is changed in the case of performing submerged arc welding with two electrodes.

FIG. 5B is a schematic diagram showing a state where an electrode distance is changed in the case of performing submerged arc welding with three electrodes.

FIG. 5C is a schematic diagram showing a state where an electrode distance is changed in the case of performing submerged arc welding with four electrodes.

FIG. 6A is a plan view of main portions for explaining a method of measuring a strain rate.

FIG. 6B is a schematic cross-sectional view for explaining a method of measuring a strain rate.

FIG. 7 is a graph used to determine a strain rate.

FIG. 8 is a cross-sectional view of a welded joint showing a surface bead and a penetration bead.

FIG. 9 is an enlarged plan view of steel plates and tab plates which have been tack welded in a third embodiment of the present invention.

FIG. 10 is an enlarged plan view of steel plates and tab plates which have been tack welded in a modification of the third embodiment.

FIG. 11 is a cross-sectional view of a tack welded portion.

### DESCRIPTION OF EMBODIMENTS

### First Embodiment

Hereinafter, a one-side submerged arc welding method and a one-side submerged arc welding device in a first embodiment of the present invention are described in detail with reference to the drawings.

First, an outline of main portions of a one-side submerged arc welding device 10 (hereinafter, also referred to as welding device 10) is described.

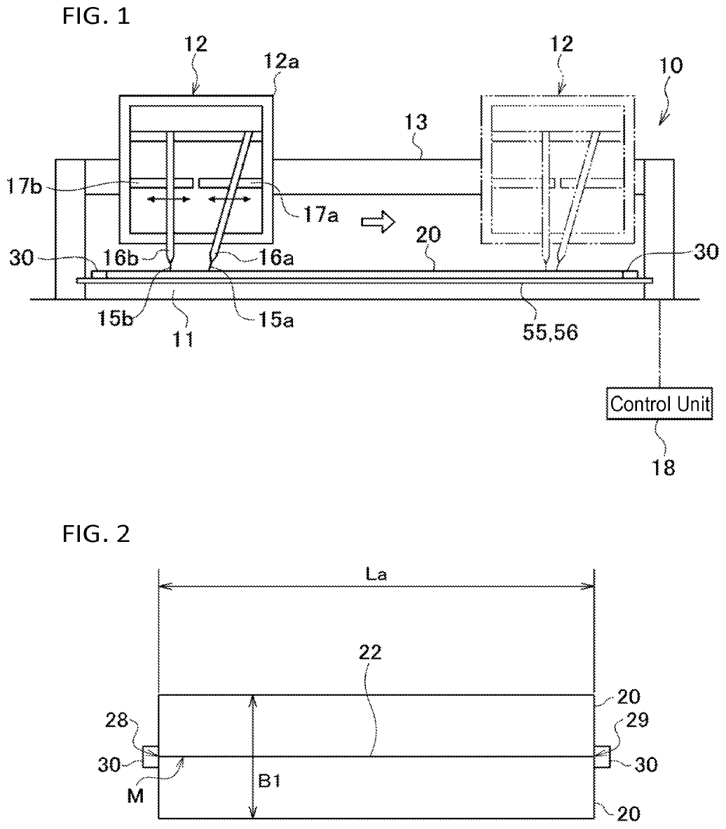

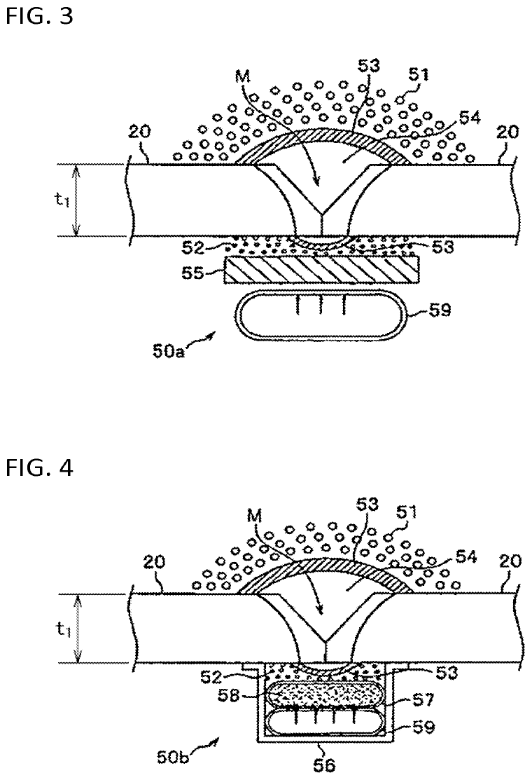

As shown in FIG. 1, the welding device 10 mainly includes a base frame 11, welders (welding units) 12, a welder beam 13, and a control unit 18. The base frame 11 is formed by a steel square bar and is formed in a concave shape in a cross-sectional view with an upper side opened, and includes a backing device 50a or a backing device 50b (see FIG. 3 and FIG. 4) supported therein. A steel plate 20 is placed on a backing copper plate 55 of the backing device 50a or a fireproof canvas 56 of the backing device 50b.

The welder beam 13 allows the welders 12 to move along a longitudinal direction of the steel plate 20.

Each of the welders 12 is disposed in a casing 12a along the longitudinal direction of the steel plate 20, and includes a first electrode 15a preceding during welding, and a second electrode 15b following the first electrode 15a. The electrodes 15a and 15b are disposed to be inserted into a first torch 16a and a second torch 16b, respectively. In addition, the torches 16a and 16b are connected via cables to a first power source (not shown) and a second power source (not shown), respectively, for supplying a current at a specified voltage. The first electrode 15a and the second electrode 15b are supplied with a current via the first torch 16a and the second torch 16b, respectively. The electrodes 15a and 15b are welding wires.

The welder 12 includes a first drive mechanism (slider) 17a which allows the first torch 16a to move along the longitudinal direction of the steel plate 20 with respect to the casing 12a and a second drive mechanism (slider) 17b which allows the second torch 16b to move along the longitudinal direction of the steel plate 20 with respect to the casing 12a. The first drive mechanism 17a and the second drive mechanism 17b are each disposed in the casing 12a. The first torch 16a and the second torch 16b are moved by the first drive mechanism 17a and the second drive mechanism 17b, so that the first electrode 15a and the second electrode 15b are moved.

The welder 12 is disposed above the base frame 11 (above the steel plate 20), moves at a specified speed along an extension direction (specified direction) of the welder beam 13 and welds the steel plate 20 by one-side submerged arc welding with the electrodes 15a and 15b from the front side of a groove M (see FIG. 3) of the steel plate 20.

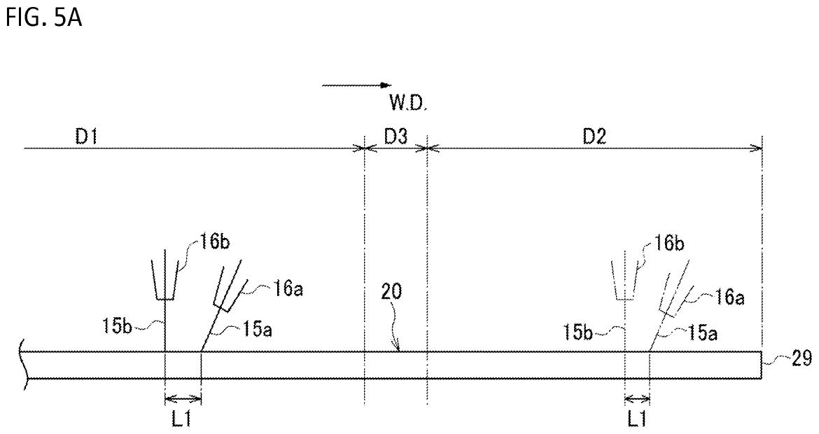

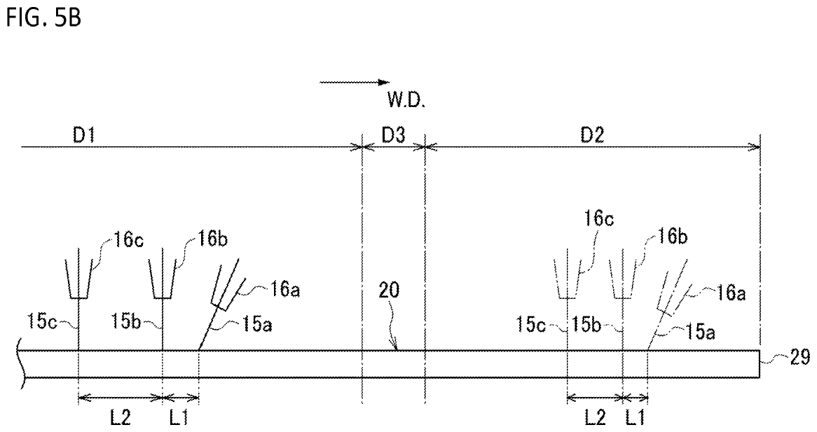

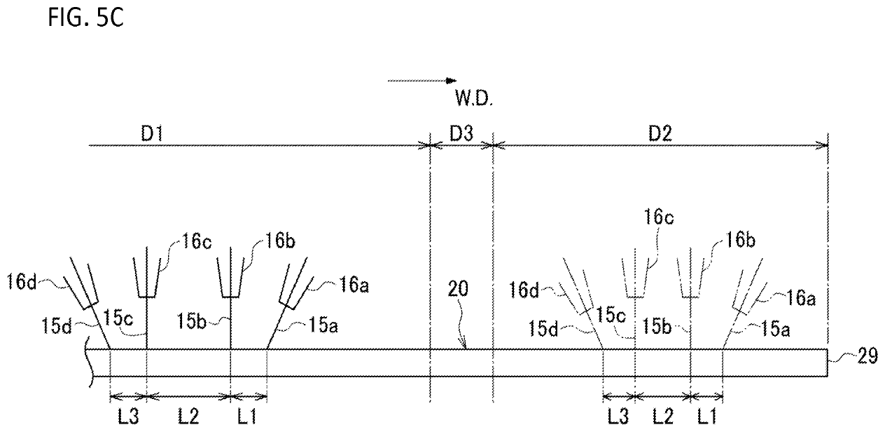

Further, the welder 12 drives and controls the first drive mechanism 17a and the second drive mechanism 17b by the control unit 18, so that the first electrode 15a and the second electrode 15b can be moved along the welder beam 13, and an electrode distance L1 between the first electrode 15a and the second electrode 15b can be changed (see FIG. 5A). The welder 12 may include only one of the drive mechanisms 17a and 17b. In addition, in the present embodiment, the electrode distance refers to a distance between electrodes at the surface height of steel plates to be welded.

In FIG. 1 and FIG. 5A, only two electrodes, i.e. the first electrode 15a and the second electrode 15b, are shown as electrodes (welding torch), but the number of electrodes is appropriately selected depending on the thickness of the steel plate 20 to be arc-welded, and it is optional to provide two or more electrodes. With regard to the number of the electrodes, one electrode is unsuitable for welding thick steel plates, and high efficiency of welding can be achieved with 5 or more electrodes, but there is room for further improvement for achieving both of the efficiency and the welding quality. When the number of the electrodes is 2 or more, it can be applied to welding of thick steel plates. On the other hand, when the number of the electrodes is 4 or less, the efficiency of welding can be enhanced, and the welding quality can be further improved. Accordingly, with two to four electrodes, it can be applied to thick steel plates, and it is easier to achieve both high efficiency and welding quality.

Therefore, the welder 12 may include, for example, first to third electrodes 15a, 15b and 15c as shown in FIG. 5B, or may include first to fourth electrodes 15a, 15b, 15c, and 15d as shown in FIG. 5C. In addition, in a welder including 3 or more electrodes, a power source and a drive mechanism can also be provided for each electrode.

As shown in FIG. 3 and FIG. 4, the one-side submerged arc welding method (hereinafter, also referred to as “the present welding”) is a method of performing welding by pressing a backing flux 52 spread in layers on the backing copper plate 55 or a backing flux 52 housed in the fireproof canvas 56 from back surfaces of the butted steel plates 20, 20 with a lifting mechanism such as an air hose 59. In the one-side submerged arc welding method, the submerged arc welding is performed from the front side of the steel plate 20 using a front flux 51 to simultaneously form beads on the front and back surfaces of the steel plate 20. In the drawings, reference numeral 53 denotes a slag, reference numeral 54 denotes a weld metal, reference numeral 57 denotes a flux bag, and reference numeral 58 denotes an underlying flux.

The steel plate 20 to which the one-side submerged arc welding method of the present embodiment is applied is, for example, a steel plate for shipbuilding. As shown in FIG. 2 and FIG. 3, a thickness t1 of the steel plate 20 is 5 mm or more and 40 mm or less, preferably 10 mm or more and 30 mm or less, and more preferably 18 mm or more and 25 mm or less. In addition, a total width B1 of the two steel plates 20 butted each other is 300 mm or more. Further, a length La of the steel plate 20 is 1000 mm or more and 35000 mm or less.

The groove M is formed in a joint surface 22 in which the two steel plates 20 are butted each other. The shape of the groove M may be any shape such as a Y groove or a V groove.

In addition, in the present embodiment, intermittent or continuous in-plane tacking is performed on the joint surface 22 of the steel plates 20. That is, in the present embodiment, no sealing cascade bead is formed.

Further, tab plates 30 are each attached to a start end 28 and a terminal end 29 of the steel plate 20. The tab plate 30 is used for the purpose of escaping a molten pool (crater) finally solidified from the welded joint in the one-side submerged arc welding, and for more effectively preventing cracks of the weld metal at the joint terminal end portion by the one-side submerged arc welding. Particularly, the tab plate 30 restrains the steel plate 20 at the joint terminal end portion, so that the thermal deformation due to the welding is prevented and the cracks at the joint terminal end portion are prevented.

Thereafter, the present welding (one-side submerged arc welding) of the steel plates 20 is performed from the start end 28 to the terminal end 29 of the steel plates 20. The present welding speed is, for example, 300 mm/min to 1,500 mm/min (30 cpm to 150 cpm). When the present welding speed is 300 mm/min to 1,500 mm/min, the welding quality can be ensured stably for the steel plate 20 having a thickness of 5 mm or more and 40 mm or less.

The “present welding” refers to welding to be performed on the steel plate 20 on which tack welding has been performed. In addition, “the present welding speed” refers to a speed of the submerged arc welding which is generally performed in the related art. Generally, the welding speed in the present welding is constant, but the speed may be slightly reduced depending on the welding position for the convenience of the welding process. However, the welding speed of the present welding is an optimum speed of the present welding conditions, that is, the preset present welding speed.

At this time, when the welding is performed under the same welding conditions (for example, specified number of electrodes, welding speed, total heat input, and electrode distance) from the start end 28 to the terminal end 29, cracks may occur at the joint terminal end portion. For example, under the condition of a high welding speed, rotational deformation may occur at the joint terminal end portion from the inner side to the outer side of the steel plate 20, and cracks may occur at the terminal end. Specifically, the strain rate at which the steel plate 20 spreads from the inner side to the outer side increases, and the driving force in the direction of cracks of the steel plate 20 increases. In addition, depending on the welding conditions, there may be a case where a penetration shape with poor crack resistance is formed at the joint terminal end portion.

Here, in the present embodiment, as shown in FIG. 1 and FIG. 5A, during the submerged arc welding in which the strain rate is low and a penetration shape good for crack resistance can be obtained at the joint terminal end portion, the electrode distance L1 between the adjacent electrodes 15a and 15b is changed (narrowed or widened) in a terminal end region D2 from a position at least 300 mm or more in front of the terminal end 29 of the steel plate 20 to the terminal end 29 and a region D1 (including the start end 28) in front of the terminal end region. That is, the change of the electrode distance can be performed by the control unit 18 through the control of the drive mechanisms 17a and 17b to allow the first and second electrodes 15a and 15b to move relative to each other during the movement of the casing 12a along the groove M.

That is, in the present embodiment, by changing the electrode distance in the terminal end region D2 to a specified value depending on the welding conditions such as the number of electrodes, the welding speed, and the heat input in the region D1 in front of the terminal end region, the strain rate is reduced, the penetration shape is changed by the first and second electrodes 15a and 15b, and the penetration shape with good crack resistance is ensured. Accordingly, the crack prevention can be achieved, and a welded joint having a good surface bead appearance can be produced. Particularly in a case where the welding speed is high, the terminal end is likely to crack, but in the welding method of the present embodiment, good penetration shape can be obtained, the strain rate can be reduced, and the prevention of the cracks of the terminal end can be achieved, even in the case where the welding speed is high. In the submerged arc welding method in the related art, there is no viewpoint of changing the electrode distance during the welding. On the other hand, the submerged arc welding method in the present embodiment has been completed as a result of intensive investigations by the inventors focusing on the penetration shape and the strain rate.

More specifically, the penetration shape with good crack resistance is obtained in the terminal end region D2 and the crack prevention can be achieved by, for example, reducing the electrode distance in the terminal end region D2 to be smaller than the electrode distance in the region in front of the terminal end region D2.

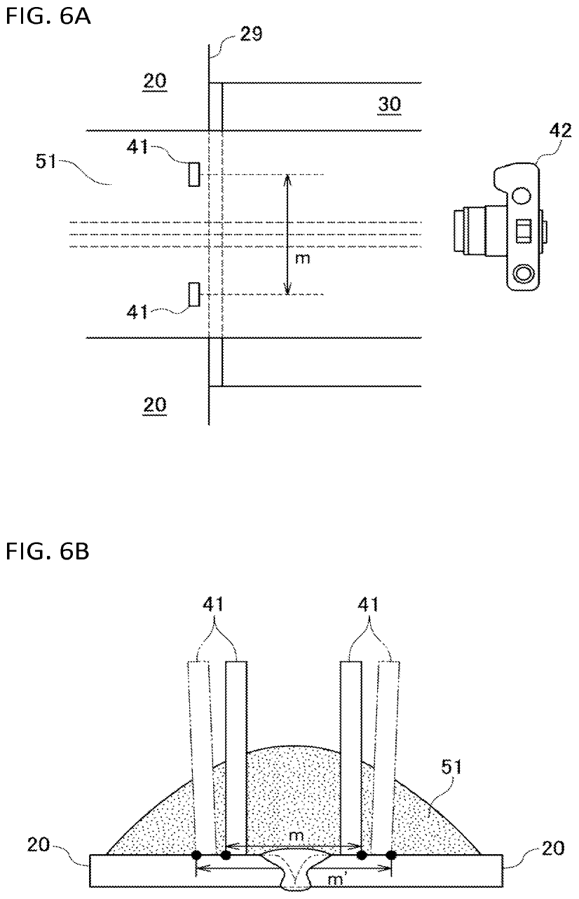

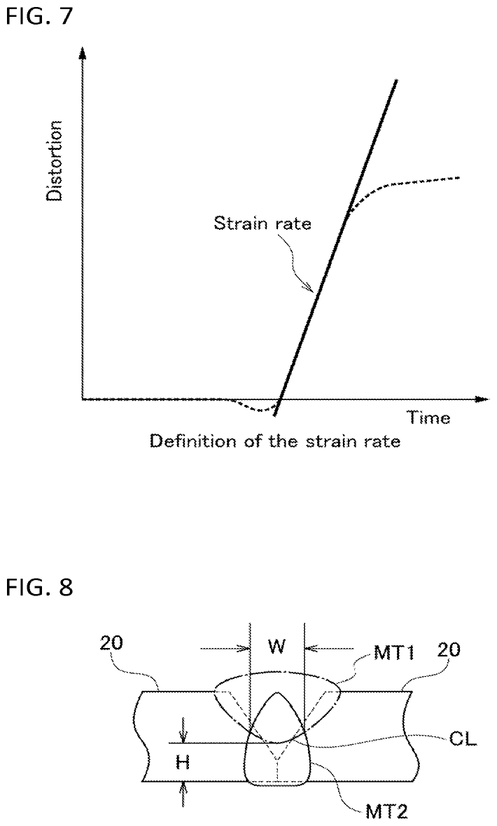

In present embodiment, regarding the evaluation of the strain rate of the steel plate as an index representing the driving force of the crack, as shown in FIG. 6A, a bar 41 for measurement of deformation is provided in the vicinity of the terminal end 29 of the steel plate 20, and as shown in FIG. 6B, the displacement (expansion from a relative distance m to m′) of the bar 41 due to the deformation of the terminal end 29 which occurs during the welding is photographed and observed by an electronic camera 42. The image data obtained from the electronic camera 42 is analyzed and plotted on a graph (see FIG. 7) of strain on the vertical axis and time on the horizontal axis to determine, as the strain rate (mm/s), the maximum value of displacement rate in an opening direction of the joint. Here, in a case where the strain rate is more than 0.10 mm/s, cracks are likely to occur. Thus, the strain rate is preferably 0.10 mm/s or less, and more preferably 0.03 mm/s or less.

The evaluation of the penetration shape as an index indicating the strength of the material with respect to a crack is described. In a welded portion to be evaluated, cutting is performed in a plane perpendicular to the welding direction, and polishing and appropriate etching are performed to obtain a cross section as shown in FIG. 8. Here, when a distance from a cross plane CL of a weld metal MT1 constituting a surface bead formed by the second electrode and a weld metal MT2 constituting a penetration bead formed by the first electrode to the back surface of the steel plate 20 is H, and the width of the cross plane CL of the weld metal MT1 and the weld metal MT2 is W, in a case where the value of H/W is 0.1 or more and 0.8 or less, a good penetration shape for crack resistance is obtained. The case where the value of H/W is less than 0.1 is not preferred, since the stability of the penetration bead shape is reduced. On the other hand, in a case where the value of H/W is more than 0.8, since cracks are likely to occur, the penetration shape is defective. Further, when the value of H/W is 0.3 or more and 0.6 or less, a better penetration shape is obtained.

The penetration shape (H/W) is influenced by the change in the temperature of the molten pool when the second electrode is used to perform the welding due to the time from the welding of the first electrode to the arrival of the second electrode (welding speed and electrode distance) and the heat input. When the temperature of the molten pool changes, the penetration depth of the second electrode changes, and thus, the value of H/W changes.

As shown in FIG. 5B, in a case where the number of the electrodes is 3, the weld metal MT1 constituting the surface bead is formed by the third electrode 15c, and the weld metal MT2 constituting the penetration bead is formed by the first and second electrodes 15a and 15b. In this case, it is preferable to change the electrode distance between the second electrode 15b and the third electrode 15c.

In addition, as shown in FIG. 5C, in a case where the number of the electrodes is 4, the weld metal MT1 constituting the surface bead is formed by the third and fourth electrodes 15c and 15d, and the weld metal MT2 constituting the penetration bead is formed by the first and second electrodes 15a and 15b. Thus, the cross plane CL of the weld metals MT1 and MT2 is provided whenever the number of the electrodes is 3 or 4. In addition, in this case, it is preferable to change the electrode distance between the second electrode 15b and the third electrode 15c.

The change of the electrode distance L1 between the first and second electrodes 15a and 15b may be performed at position(s) from any position in front of the terminal end to the terminal end 29 of the steel plate 20. However, it is desirable to change the electrode distance L1 from a position where the amount of deformation is small depending on the length La of the steel plate 20. For example, the change of the electrode distance L1 is preferably performed at a position which is in front of the terminal end 29 of the steel plate 20 and is at least 150 mm away from the terminal end 29, more preferably performed at a position which is in front of the terminal end 29 of the steel plate 20 and is at least 300 mm away from the terminal end 29, still more preferably performed at a position which is in front of the terminal end 29 of the steel plate 20 and is at least 500 mm away from the terminal end 29, and particularly preferably performed at a position which is in front of the terminal end 29 of the steel plate 20 and is at least 1000 mm away from the terminal end 29.

In addition, the change of the electrode distance L1 may be performed in a transitional region D3 between the region D1 which is in front of the terminal end region and the terminal end region D2.

That is, in the welding of the steel plate 20 in the present embodiment, when the first and second electrodes 15a and 15b come to the transitional region D3 which is slightly closer to the start end 28 than a position which is in front of the terminal end 29 of the steel plate 20 and is at least 150 mm away from the terminal end 29, control of the drive mechanisms 17a, 17b gradually starts, and when the first and second electrodes 15a and 15b come to the terminal end region D2, the change of the electrode distance L1 is completed. The length of the transitional region D3 is not particularly limited, but is, for example, 50 mm to 500 mm.

In a case where the welder 12 includes two electrodes of the first electrode and the second electrode, the electrode distance L1 between the first electrode and the second electrode is changed in the range of 10 mm to 250 mm. For example, in a case where the electrode distance in the present welding is 30 mm to 140 mm, it is preferable that the welding is performed such that the electrode distance is 20 mm to 80 mm in the terminal end region.

In a case where the welder 12 includes three electrodes of the first electrode, the second electrode and the third electrode, it is preferable to change the electrode distance L1 between the first electrode and the second electrode in the range of 10 mm to 250 mm, and change an electrode distance L2 between the second electrode and the third electrode in the range of 10 mm to 250 mm. For example, in a case where the electrode distance between the second electrode and the third electrode in the present welding is 10 mm to 170 mm, it is preferable that the welding is performed such that the electrode distance between the second electrode and the third electrode is 35 mm to 140 mm in the terminal end region.

Further, in a case where the welder 12 includes four electrodes of the first electrode, the second electrode, the third electrode and the fourth electrode, it is preferable to change the electrode distance L1 between the first electrode and the second electrode in the range of 10 mm to 250 mm, change the electrode distance L2 between the second electrode and the third electrode in the range 10 mm to 250 mm, and change an electrode distance L3 between the third electrode and the fourth electrode in the range 10 mm to 250 mm.

In addition, in a case where the number of the electrodes is 3 or 4, at least one of the plurality of electrode distances may be changed. For example, in a case where the number of the electrodes is 4 and the electrode distance between the second electrode and the third electrode in the present welding is 30 mm to 200 mm, it is preferable that the welding is performed such that the electrode distance between the second electrode and the third electrode is 30 mm to 170 mm in the terminal end region. In this case, the electrode distance between the first electrode and the second electrode and the electrode distance between the third electrode and the fourth electrode may be constant.

In a case of using three electrodes, as described above, since the weld metal MT1 constituting the surface bead is formed by the third electrode 15c, and the weld metal MT2 constituting the penetration bead is formed by the first and second electrodes 15a and 15b, it is preferable to change the electrode distance L2 between the second electrode 15b and the third electrode 15c, which influences the position of the cross plane CL.

In addition, in a case of using four electrodes, since the weld metal MT1 constituting the surface bead is formed by the third and fourth electrodes 15c and 15d, and the weld metal MT2 constituting the penetration bead is formed by the first and second electrodes 15a and 15b, it is preferable to change the electrode distance L2 between the second electrode 15b and the third electrode 15c, which influences the position of the cross plane CL also in this case.

### Second Embodiment

Next, the one-side submerged arc welding method of a second embodiment is described. The welding device 10 used in the present embodiment is the same as that of the first embodiment.

In the one-side submerged arc welding method of the present embodiment, unlike the first embodiment in which the welding speed is constant from the start end 28 to the terminal end 29 of the steel plate 20, the welding is performed at a position which is in front of the terminal end of the steel plate 20 and is at least 300 mm away from the terminal end to the terminal end 29 at a welding speed (hereinafter, referred to as a reduced welding speed appropriately) which is equal to or less than 75% of the welding speed of the present welding (hereinafter, referred to as the present welding speed appropriately).

At this time, when the total heat input in the present welding is Q (kJ/mm) and the total heat input in the welding at a welding speed of 75% or less is Q′ (kJ/mm), “Q′/Q=0.60 to 1.30”.

When the reduced welding speed in the terminal end region D2 is equal to or less than 75% of the present welding speed, in the terminal end region D2, the strain rate can be reduced, and the driving force of the crack can be reduced, and in some cases, contraction deformation which leads to rotational deformation occurring from the inner side to the outer side of the steel plate 20 occurs. The reduced welding speed is preferably equal to or less than 60% of the present welding speed, and is more preferably equal to or less than 50% of the present welding speed. When the reduced welding speed is equal to or more than 40% of the present welding speed, the welding efficiency is not significantly impaired. In addition, when the reduced welding speed is equal to or more than 40% of the present welding speed, the current value for ensuring a good weld metal is high, it is not difficult to maintain the arc and the bead appearance is good.

In addition, in the welding of the steel plate 20, in a case where the welding speed is changed, the heat input is excessive and it is difficult to ensure the effect of prevention of the cracks and the welding quality, due to a low speed. That is, when the total heat input in the welding at a reduced welding speed is more than 1.30 times the total heat input at the present welding speed, the crack prevention effect is not recognized, and regarding the welding quality, the reinforcement of the penetration bead is excessive, making it impossible to obtain a good weld metal. On the other hand, when the total heat input in the welding at the reduced welding speed is less than 0.60 times the total heat input at the present welding speed, the crack prevention effect is recognized, but it is difficult to maintain the arc, and it is impossible to obtain a good weld metal for both the surface and penetration beads. Therefore, when the total heat input in the present welding is Q (kJ/mm) and the total heat input in the welding at a welding speed of 75% or less is Q′ (kJ/mm), “Q′/Q=0.60 to 1.30”.

From the viewpoint of making it easier to obtain a good weld metal, the value of Q′/Q is preferably 0.70 or more, and more preferably 0.80 or more. In addition, from the viewpoint of the crack prevention effect in the terminal end region D2 and making it easier to obtain a good weld metal, the value of Q′/Q is preferably 1.20 or less.

The total heat input Q can be calculated by the following formula.

$$Q = {\sum }_{i = 1}^{n} \frac{{v}_{i}}{{E}_{i} \times {I}_{i}} \times 0.06 \qquad [ Math . 1 ]$$

In the above formula, Q represents the total heat input (kJ/mm), Eᵢ represents the voltage (V), Iᵢ represents the current (A), vᵢ represents the welding speed (mm/min), i=1, 2, 3, . . . n, and i represents each electrode. The same applies to Q′ for the above formula. In addition, the total heat input here means the total of the heat inputs of the electrodes 15a, 15b . . . . In addition, the total heat input may be a value calculated by the above formula, or may be an actual measurement value (measurement value).

In the present embodiment, from the viewpoint of the amount of deformation at joint terminal end portion, it is preferable that the change range of the welding speed is the terminal end region D2 from a position which is in front of the terminal end of the steel plate 20 and is at least 300 mm away from the terminal end to the terminal end 29. In addition, the transitional region D3 in which the welding speed is changed from the present welding speed to the reduced welding speed may be appropriately set in the range of 50 mm to 500 mm.

Further, the change of the electrode distance and the change of the welding speed may be performed simultaneously or separately within the above range. Therefore, the change of the electrode distance may be performed from any position in front of the terminal end of the steel plate 20 to the terminal end 29.

Accordingly, when the welding speed (moving speed of the casing 12a) is reduced, the strain rate of the steel plate 20 is reduced, so that the driving force of the cracks can be reduced, but a penetration shape with poor crack resistance may be obtained. In contrast, as in the present embodiment, when the electrode distance is changed, the strain rate of the steel plate 20 is reduced, the penetration shape (H/W) with good crack resistance can be ensured, and crack prevention can be achieved.

For example, when the heat input is constant and the welding speed is reduced, since the temperature of the molten pool at the time of welding of the electrode to form the weld metal MT1 (see FIG. 8) is low, penetration of the electrode is shallow, H/W is large, and crack resistance is degraded. When the electrode distance is shortened at this time, since the temperature of the molten pool at the time of welding of the electrode to form the weld metal MT1 is high, the penetration of the electrode is deep, and H/W can be maintained in a range with good crack resistance.

Particularly, from the viewpoint of welding efficiency, the reduction in the welding speed is preferably as small as possible, and when the change of the electrode distance and the change of the welding speed are performed, for example, the crack prevention can be achieved while making the reduced welding speed higher than 70% of the present welding speed.

Other configurations and effects are similar to those of the first embodiment.

### Third Embodiment

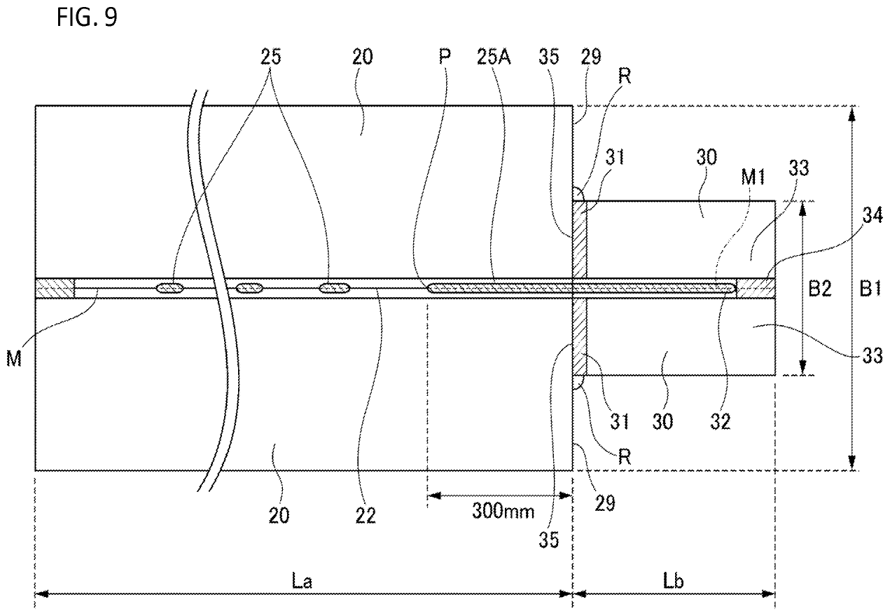

Next, the one-side submerged arc welding method of a third embodiment is described with reference to FIG. 9 to FIG. 11. The welding device 10 used in the present embodiment is the same as that of the first embodiment.

In the present embodiment, the tab plate 30 used is specified with respect to the steel plate 20 having a thickness, a width, and a length similar to those in the first embodiment. That is, in the present embodiment, at the terminal end 29 of the steel plate 20, one end edges 35 of two tab plates 30, 30 are butted each other and joined together before the present welding is performed. The two tab plates 30, 30 are joined by applying reinforcement welding (reinforcement welded portion 34) to each terminal end portions 33, then the joint surface 22 of the steel plates 20 and a joint surface 32 of the tab plates 30 are linearly continued, and the terminal ends 29 of the two steel plates 20, 20 and the one end edges 35 of the two tab plates 30, 30 are disposed to be abut with each other on a tack surface plate. Then, reinforcement welding (reinforcement welded portion 31) is applied to the terminal ends 29 of the two steel plates 20, 20 and one end edges of the two tab plates 30, 30, corner winding welding is applied to end portions R of the two tab plates 30, 30, and tack welding (tack welded portions 25 and 25A) to be described later is applied to the joint surface 22 of steel plates 20, and the joint surface 32 of tab plates 30.

The joining order of joining the two tab plates 30, 30 to the steel plates 20 is not limited to the above.

A thickness t2 of the tab plate 30 is equal to or larger than a thickness t1 of the steel plate (t2≥t1). A total width B2 of the two tab plates 30 is smaller than a width B1 of the steel plates (B2<B1), is at least 10 times the thickness t1 of the steel plate (B2≥10×t1), and is 100 mm or more and 2000 mm or less. In addition, a length Lb of the tab plate 30 is 100 mm or more and 1000 mm or less.

As described above, the tab plate 30 is used for the purpose of escaping a crater from the welded joint in one-side submerged arc welding and for more effectively preventing cracks of the weld metal at the joint terminal end portion.

In the one-side submerged arc welding, as the thickness of the steel plate 20 increases, it is necessary to increase the welding heat input, and thermal deformation also increases. Therefore, in order to prevent the thermal deformation, it is necessary to increase the restraining force as the thickness of the steel plate 20 increases. However, since cracks also occur when excessive restraint is performed, it is important to provide an appropriate restraining force.

The restraining force on the steel plate 20 by the tab plate 30 can be strengthened by increasing the rigidity of the tab plate 30 in a direction perpendicular to the welding direction, and can be controlled by the width of the tab plate 30 and the thickness of the tab plate 30. That is, by appropriately specifying the width and thickness of the tab plate 30 with respect to the thickness of the steel plate 20, the thermal deformation force can be smaller than the restraining force, and cracks can be prevented at the joint terminal end portion.

In the present embodiment, a slit is not formed in the tab plate 30 unlike the tab plates in the related art. In a case where a slit is formed in the tab plate 30, the slit weakens the restraining force on the steel plate 20, so that it is necessary to set the tab plate 30 larger than the tab plate 30 without a slit. Particularly during welding of thick plates that require high heat input, in order to have sufficient restraining force on the steel plate 20, the tab plate 30 would be necessary to be enlarged and the actual operation may be difficult.

In addition, a groove M1 is also formed on an end surface where the two tab plates 30 are butted each other. The shape of the groove M1 is not particularly limited as long as it is substantially the same shape as the groove M of the steel plate 20, and may be any shape such as Y groove or V groove. In addition, in the grooves M and M1 of the steel plate 20 and the tab plate 30, groove angles of the Y groove and the V groove may have variations within an industrially acceptable range.

For example, in a case where there is one tab plate 30, or in a case where the groove M1 different from that of the steel plate 20 is formed for the two tab plates 30, or in a case where the groove M1 is not formed for the two tab plates 30, the groove shapes of the steel plate 20 and tab plate 30 are different, so that there are concerns that the welded joint terminal end portion may be discontinuous, and hot cracking, slag inclusion, a defect penetration bead shape, insufficient penetration or the like may occur.

On the other hand, as in the present embodiment, when the two tab plates 30 are used and the grooves M and M1 having substantially the same shape are formed for the steel plate 20 and the tab plate 30, respectively, the continuity between the steel plate 20 and the tab plate 30 can be ensured, and the tack welding from the rear end side of the steel plate 20 to the one end portion side of the tab plate 30 can be reliably performed.

In the present embodiment, tack welding is performed on the joint surface 22 of the steel plates 20 and the joint surface 32 of the tab plates 30. The tack welding is performed intermittently at several points on the joint surface 22 of the steel plates 20 from the start end portion (left side of the steel plate 20 in FIG. 9) side to the terminal end portion (right side of the steel plate 20 in FIG. 9) in the present welding, and is performed continuously from the steel plate 20 to the tab plate 30, that is from a position P which is in front of the terminal end portion 29 of the steel plate 20 and is at least 300 mm away from the terminal end portion 29 to the terminal end portion 33 of the tab plate 30, thereby forming the tack welded portion 25A.

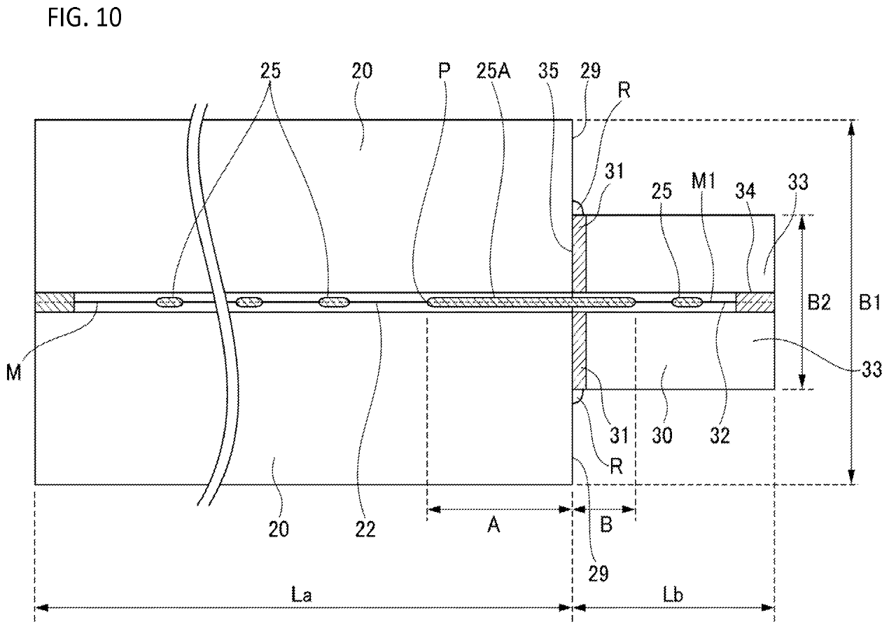

As shown in FIG. 10, in the tack welding of the present invention, the tack welded portion 25A may be formed at least from the terminal end portion side of the steel plate 20 to the one end portion side of the tab plate 30. Thus, the tack welding may be also performed on the joint surface 32 of the tab plates 30.

Since an un-joined portion to be welded is integrated during the present welding by forming the tack welded portion 25A from the terminal end portion side of the steel plate 20 to the one end portion side of the tab plate 30, the thermal deformation can be reduced. Accordingly, cracks at the joint terminal end portion can be prevented.

In the welding using a tab plate in the related art, since the tack welding is stopped at the terminal end 29 of the steel plate 20, that is, the tack welding is not performed across the one end portion side of the tab plate 30, cracks are likely to occur at the joint terminal end portion.

Here, in the tack welded portion 25A, when the length of the tack welding on the terminal end portion side of the steel plate 20 from the terminal end 29 of the steel plate 20 is A and the length of the tack welding on the one end portion side of the tab plate 30 from the terminal end 29 of the steel plate 20 is B, in a case where 20 mm≤A and 20 mm≤B are satisfied, the above effect can be more reliably exhibited.

From the viewpoint of preventing the cracks at the joint terminal end portion, 70 mm≤A and 70 mm≤B are more preferred, and 100 mm≤A and 100 mm≤B are still more preferred.

In addition, in the tack welding, the joint surface 22 of the of the steel plates 20 and the joint surface 32 of the tab plates 30 may be continuously j oined from the start end portion side of the steel plate 20 to the terminal end portion 33 of the tab plate 30.

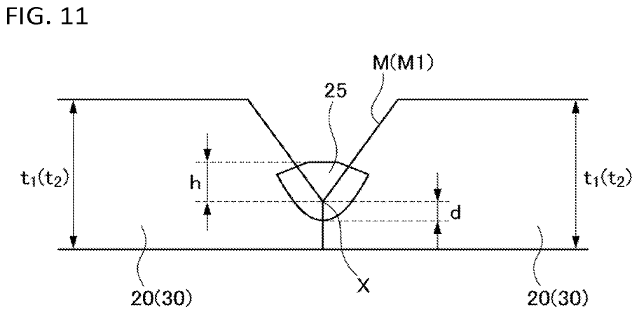

In FIG. 11, the tack welded portion 25 is formed of a single layer equivalent to a sealing bead consisting of only one layer. It is preferable that a penetration depth d of the tack welded portion 25 is 2 mm or more (d≥2 mm), and a throat thickness h is 7 mm or less (h≤7 mm).

When the penetration depth d of the tack welded portion 25 is less than 2 mm, during the present welding, the joining effect of the tack welded portion 25 is weak at the un-joined portion to be welded by the present welding, and there is a concern that the tack welded portion may break during the present welding. Thus, the penetration depth d is preferably 2 mm or more. Further, when the throat thickness h of the tack welded portion 25 is 7 mm or less (which may be any of single layer and lamination), during the present welding, the penetration bead is more easily formed on the tack welded portion 25, the reworking is avoided, and the working efficiency is improved.

As described above, when the one-side submerged arc welding method is applied to the steel plate 20 and the tab plate 30, which had been subjected to the tack welding, using the welding device 10 including a plurality of electrodes 15a and 15b as in the first or second embodiment, cracks at the terminal end can be prevented more efficiently.

Other configurations and effects are similar to those of the first or second embodiment. In addition, in the submerged arc welding method in the third embodiment, the welding speed may be reduced in the terminal end region as in the submerged arc welding method in the second embodiment. In this case, the penetration shape can be improved and the strain rate can be reduced.

The present invention is not limited to the embodiments described above and Examples, and appropriate modifications, improvements, or the like can be made.

In the above embodiments, it is described that the tab plate 30 is attached to the start end 28 and terminal end 29 of the steel plate 20, but in the present invention, a submerged arc welding method may be performed without using the tab plate 30.

### EXAMPLES

### (Test 1)

In order to confirm the effects of the present invention, in Test 1, the one-side submerged arc welding was performed with changing only the electrode distance in the terminal end portion region, and the penetration shape at the joint terminal end portion, the strain rate of the steel plate, and the cracks of the weld metal were evaluated. Table 1 shows the number of electrodes, the current and voltage applied to each electrode, the welding speed, the heat input, and the electrode distance, as well as the evaluation results of the penetration shape at the joint terminal end portion, the strain rate of the steel plate, and the cracks of the weld metal in the Examples and the Comparative Examples.

As the steel plate 20 subjected to Test 1, a rolled steel material SM400B for welded structures was used and the steel plate had a size of 20 mm in thickness, 750 mm×2 in width, and 1200 mm in width. In addition, in Test 1, the tab plate was not used, and tack welding was performed at a pitch of 600 mm on the joint surface 22 of the two steel plates 20.

Further, in No. 1 to No. 19, the electrode distance was changed in the range of 2000 mm to 1000 mm in front of the terminal end 29 of the steel plate 20.

TABLE 1

| | Number | First electrode | | Second electrode | | Third electrode | | Fourth electrode | | Welding | |
|---|---|---|---|---|---|---|---|---|---|---|---|
| | of | Current | Voltage | Current | Voltage | Current | Voltage | Current | Voltage | speed | Heat input |
| No. | electrodes | [A] | [V] | [A] | [V] | [A] | [V] | [A] | [V] | [mm/min] | [kJ/mm] |
| No. 1 | 2 | 890 | 31 | 750 | 42 | — | — | — | — | 320 | 11.1 |
| No. 2 | | | | | | — | — | — | — | | |
| No. 3 | | | | | | — | — | — | — | | |
| No. 4 | | 1150 | 33 | 1000 | 45 | — | — | — | — | 450 | 11.1 |
| No. 5 | | | | | | — | — | — | — | | |
| No. 6 | | | | | | — | — | — | — | | |
| No. 7 | 3 | 1000 | 32 | 750 | 39 | 850 | 41 | — | — | 500 | 11.5 |
| No. 8 | | | | | | | | — | — | | |
| No. 9 | | | | | | | | — | — | | |
| No. 10 | | 1300 | 35 | 1000 | 42 | 1050 | 44 | — | — | 700 | 11.5 |
| No. 11 | | | | | | | | — | — | | |
| No. 12 | | | | | | | | — | — | | |
| No. 13 | 4 | 1250 | 34 | 1050 | 37 | 800 | 35 | 900 | 36 | 740 | 11.5 |
| No. 14 | | | | | | | | | | | |
| No. 15 | | | | | | | | | | | |
| No. 16 | | 1550 | 35 | 1300 | 41 | 950 | 46 | 1050 | 48 | 1050 | 11.5 |
| No. 17 | | | | | | | | | | | |
| No. 18 | | | | | | | | | | | |

| | | | | Electrode distance after | | | Evaluation | | |
|---|---|---|---|---|---|---|---|---|---|
| | Electrode distance [mm] | | | change [mm] | | | Penetration | Strain rate | |
| No. | First/second | Second/third | Third/fourth | First/second | Second/third | Third/fourth | shape | [mm/s] | Cracks |
| No. 1 | 30 | — | — | 80 | | | 0.7 | 0.04 | ∘ |
| No. 2 | 50 | — | — | | | | 0.7 | 0.04 | ∘ |
| No. 3 | 120 | — | — | | | | 0.7 | 0.04 | ∘ |
| No. 4 | 30 | — | — | 120 | | | 0.8 | 0.06 | ∘ |
| No. 5 | 50 | — | — | | | | 0.8 | 0.06 | ∘ |
| No. 6 | 100 | — | — | | | | 0.8 | 0.06 | ∘ |
| No. 7 | 35 | 10 | — | 35 | 80 | | 0.7 | 0.05 | ∘ |
| No. 8 | | 30 | — | | | | 0.7 | 0.05 | ∘ |
| No. 9 | | 170 | — | | | | 0.7 | 0.05 | ∘ |
| No. 10 | 35 | 10 | — | 35 | 120 | | 0.8 | 0.08 | Δ |
| No. 11 | | 30 | — | | | | 0.8 | 0.08 | Δ |
| No. 12 | | 170 | — | | | | 0.8 | 0.08 | Δ |
| No. 13 | 30 | 80 | 30 | 30 | 140 | 30 | 0.8 | 0.06 | ∘ |
| No. 14 | | 110 | | | | | 0.8 | 0.06 | ∘ |
| No. 15 | | 170 | | | | | 0.8 | 0.06 | ∘ |
| No. 16 | 30 | 80 | 30 | 30 | 170 | 30 | 0.7 | 0.09 | Δ |
| No. 17 | | 110 | | | | | 0.7 | 0.09 | Δ |
| No. 18 | | 140 | | | | | 0.7 | 0.09 | Δ |

| | Number | First electrode | | Second electrode | | Third electrode | | Fourth electrode | | Welding | |
|---|---|---|---|---|---|---|---|---|---|---|---|
| | of | Current | Voltage | Current | Voltage | Current | Voltage | Current | Voltage | speed | Heat input |
| No. | electrodes | [A] | [V] | [A] | [V] | [A] | [V] | [A] | [V] | [mm/min] | [kJ/mm] |
| No. 19 | 2 | 890 | 31 | 750 | 42 | — | — | — | — | 320 | 11.1 |
| No. 20 | | | | | | — | — | — | — | | |
| No. 21 | | | | | | — | — | — | — | | |
| No. 22 | | 1150 | 33 | 1000 | 45 | — | — | — | — | 450 | 11.1 |
| No. 23 | | | | | | — | — | — | — | | |
| No. 24 | | | | | | — | — | — | — | | |
| No. 25 | 3 | 1000 | 32 | 750 | 39 | 850 | 41 | — | — | 500 | 11.5 |
| No. 26 | | | | | | | | — | — | | |
| No. 27 | | | | | | | | — | — | | |
| No. 28 | | 1300 | 35 | 1000 | 42 | 1050 | 44 | — | — | 700 | 11.5 |
| No. 29 | | | | | | | | — | — | | |
| No. 30 | | | | | | | | — | — | | |
| No. 31 | 4 | 1250 | 34 | 1050 | 37 | 800 | 35 | 900 | 36 | 740 | 11.5 |
| No. 32 | | | | | | | | | | | |
| No. 33 | | | | | | | | | | | |
| No. 34 | | 1550 | 35 | 1300 | 41 | 950 | 46 | 1050 | 48 | 1050 | 11.5 |
| No. 35 | | | | | | | | | | | |
| No. 36 | | | | | | | | | | | |

| | | | | Electrode distance after | | | Evaluation | | |
|---|---|---|---|---|---|---|---|---|---|
| | Electrode distance [mm] | | | change [mm] | | | Penetration | Strain rate | |
| No. | First/second | Second/third | Third/fourth | First/second | Second/third | Third/fourth | shape | [mm/s] | Cracks |
| No. 19 | 30 | — | — | — | — | — | 0.0 | 0.06 | x |
| No. 20 | 50 | — | — | — | — | — | 0.0 | 0.06 | x |
| No. 21 | 120 | — | — | — | — | — | 1.0 | 0.06 | x |
| No. 22 | 30 | — | — | — | — | — | 0.0 | 0.15 | x |
| No. 23 | 50 | — | — | — | — | — | 0.0 | 0.15 | x |
| No. 24 | 100 | — | — | — | — | — | 0.7 | 0.15 | x |
| No. 25 | 35 | 10 | — | — | — | — | 0.0 | 0.06 | x |
| No. 26 | | 30 | — | — | — | — | 0.0 | 0.06 | x |
| No. 27 | | 170 | — | — | — | — | 1.0 | 0.06 | x |
| No. 28 | 35 | 10 | — | — | — | — | 0.0 | 0.15 | x |
| No. 29 | | 30 | — | — | — | — | 0.0 | 0.15 | x |
| No. 30 | | 170 | — | — | — | — | 1.0 | 0.15 | x |
| No. 31 | 30 | 80 | 30 | — | — | — | 0.0 | 0.06 | x |
| No. 32 | | 110 | | — | — | — | 0.0 | 0.06 | x |
| No. 33 | | 170 | | — | — | — | 0.9 | 0.06 | x |
| No. 34 | 30 | 80 | 30 | — | — | — | 0.0 | 0.15 | x |
| No. 35 | | 110 | | — | — | — | 0.0 | 0.15 | x |
| No. 36 | | 140 | | — | — | — | 0.7 | 0.15 | x |

Regarding the evaluation on the strain rate of the steel plate, as described in the first embodiment, a strain rate of 0.10 mm/s or less was evaluated as passed, and a strain rate of 0.03 mm/s or less was a more desirable value. In addition, regarding the evaluation on the penetration shape with respect to cracks, as described in the first embodiment, in a case where the value of H/W was 0.1 or more and 0.8 or less, the penetration shape was evaluated as good. Further, a value of H/W of 0.3 or more and 0.6 or less was a more desirable value.

Regarding the crack evaluation, the presence or absence of internal cracks by an X-ray transmission test (JIS Z3104) within the range from the position which is in front of the terminal end of the steel plate and is 400 mm away from the terminal end to the terminal end was confirmed after the welding, when no crack was found, it was evaluated as ∘; when cracks was recognized but it was a level that could be put to practical use, it was evaluated as Δ; and when cracks which could not be put to practical use was found, it was evaluated as x.

In Table 1, No. 1 to No. 18 are Examples, and No. 19 to No. 36 are Comparative Examples. That is, in No. 19 to No. 36 in which the submerged arc welding was performed under the same welding conditions from the start end to the terminal end, good evaluation results were not obtained for the penetration shape at the joint terminal end portion and the strain rate. On the other hand, in No. 1 to No. 18 in which the number of electrodes, the current and voltage applied to each electrode, the welding speed, and the heat input were the same conditions as those in No. 19 to No. 36, but the electrode distance at the joint terminal end portion was changed, good evaluation results were obtained for the penetration shape at the penetration shape and the strain rate. In addition, in No. 10 to No. 12 and No. 16 to No. 18, the crack evaluation by the X-ray transmission test remained at a level that could be put to practical use, while in No. 1 to No. 9 and No. 13 to No. 15, an improvement was seen in the crack evaluation by the X-ray transmission test.

### (Test 2)

In Test 2, the one-side submerged arc welding was performed with changing the welding speed and the electrode distance in the terminal end portion region, and the penetration shape at the joint terminal end portion, the strain rate of the steel plate, and the cracks of the weld metal were evaluated. Table 2 shows the number of electrodes, the current and voltage applied to each electrode before and after the change, the welding speed before and after the change, the heat input before and after the change, and the electrode distance before and after the change, as well as the evaluation results of the penetration shape at the joint terminal end portion, the strain rate of the steel plate, and the cracks of the weld metal in the Examples.

As also the steel plate 20 subjected to Test 2, a rolled steel material SM400B for welded structures was used and the steel plate had a size of 20 mm in thickness, 750 mm×2 in width, and 1200 mm in width. In addition, in Test 2, the tab plate was not used, and tack welding was performed at a pitch of 600 mm on the joint surface 22 of the two steel plates 20.

Further, in Test 2, the welding speed and the electrode distance were changed in the range of 2000 mm to 1000 mm in front of the terminal end 29 of the steel plate 20.

TABLE 2

| | Number | | | | | | | | |
|---|---|---|---|---|---|---|---|---|---|
| | of | First electrode | | Second electrode | | Third electrode | | Fourth electrode | |
| No. | electrodes | Current [A] | Voltage [V] | Current [A] | Voltage [V] | Current [A] | Voltage [V] | Current [A] | Voltage [V] |
| No. 37 | 2 | 1150 | 33 | 1000 | 45 | — | — | — | — |
| No. 38 | | | | | | — | — | — | — |
| No. 39 | | | | | | — | — | — | — |
| No. 40 | | | | | | — | — | — | — |
| No. 41 | | 1150 | 33 | 1000 | 45 | — | — | — | — |
| No. 42 | | | | | | — | — | — | — |
| No. 43 | | | | | | — | — | — | — |
| No. 44 | | | | | | — | — | — | — |
| No. 45 | 3 | 1300 | 35 | 1000 | 42 | 1050 | 44 | — | — |
| No. 46 | | | | | | | | — | — |
| No. 47 | | | | | | | | — | — |
| No. 48 | | 1300 | 35 | 1000 | 42 | 1050 | 44 | — | — |
| No. 49 | | | | | | | | — | — |
| No. 50 | | | | | | | | — | — |
| No. 51 | 4 | 1550 | 35 | 1300 | 41 | 950 | 46 | 1050 | 48 |
| No. 52 | | | | | | | | | |
| No. 53 | | | | | | | | | |
| No. 54 | | 1550 | 35 | 1300 | 41 | 950 | 46 | 1050 | 48 |
| No. 55 | | | | | | | | | |
| No. 56 | | | | | | | | | |

| | Welding conditions after change | | | | | | | | | Welding | | |
|---|---|---|---|---|---|---|---|---|---|---|---|---|
| | First electrode | | Second electrode | | Third electrode | | Fourth electrode | | Welding | speed after | Heat | Heat input |
| | Current | Voltage | Current | Voltage | Current | Voltage | Current | Voltage | speed | change | input | after change |
| No. | [A] | [V] | [A] | [V] | [A] | [V] | [A] | [V] | [mm/min] | [mm/min] | [kJ/mm] | [kJ/mm] |
| No. 37 | 890 | 31 | 750 | 42 | — | — | — | — | 450 | 320 | 11.1 | 11.1 |
| No. 38 | | | | | | | | | | | | |
| No. 39 | | | | | | | | | | | | |
| No. 40 | | | | | | | | | | | | |
| No. 41 | 890 | 31 | 750 | 42 | — | — | — | — | 450 | 320 | 11.1 | 11.1 |
| No. 42 | | | | | | | | | | | | |
| No. 43 | | | | | | | | | | | | |
| No. 44 | | | | | | | | | | | | |
| No. 45 | 1000 | 32 | 750 | 39 | 850 | 41 | — | — | 700 | 500 | 11.5 | 11.5 |
| No. 46 | | | | | | | | | | | | |
| No. 47 | | | | | | | | | | | | |
| No. 48 | 1000 | 32 | 750 | 39 | 850 | 41 | — | — | 700 | 500 | 11.5 | 11.5 |
| No. 49 | | | | | | | | | | | | |
| No. 50 | | | | | | | | | | | | |
| No. 51 | 1250 | 34 | 1050 | 37 | 800 | 35 | 900 | 36 | 1050 | 740 | 11.5 | 11.5 |
| No. 52 | | | | | | | | | | | | |
| No. 53 | | | | | | | | | | | | |
| No. 54 | 1250 | 34 | 1050 | 37 | 800 | 35 | 900 | 36 | 1050 | 740 | 11.5 | 11.5 |
| No. 55 | | | | | | | | | | | | |
| No. 56 | | | | | | | | | | | | |

| | | | | Electrode distance after | | | Evaluation | | |
|---|---|---|---|---|---|---|---|---|---|
| | Electrode distance [mm] | | | change [mm] | | | Penetration | Strain rate | |
| No. | First/second | Second/third | Third/fourth | First/second | Second/third | Third/fourth | shape | [mm/s] | Cracks |
| No. 37 | 30 | — | — | 60 | — | — | 0.3 | 0.01 | ∘ |
| No. 38 | 50 | — | — | | — | — | 0.3 | 0.01 | ∘ |
| No. 39 | 120 | — | — | | — | — | 0.3 | 0.01 | ∘ |
| No. 40 | 140 | — | — | | — | — | 0.3 | 0.01 | ∘ |
| No. 41 | 30 | — | — | 80 | — | — | 0.5 | 0.02 | ∘ |
| No. 42 | 50 | — | — | | — | — | 0.5 | 0.02 | ∘ |
| No. 43 | 120 | — | — | | — | — | 0.5 | 0.02 | ∘ |
| No. 44 | 140 | — | — | | — | — | 0.5 | 0.02 | ∘ |
| No. 45 | 35 | 10 | — | 35 | 60 | — | 0.4 | 0.01 | ∘ |
| No. 46 | | 30 | — | | | — | 0.4 | 0.01 | ∘ |
| No. 47 | | 170 | — | | | — | 0.4 | 0.01 | ∘ |
| No. 48 | 35 | 10 | — | 35 | 80 | — | 0.6 | 0.02 | ∘ |
| No. 49 | | 30 | — | | | — | 0.6 | 0.02 | ∘ |
| No. 50 | | 170 | — | | | — | 0.6 | 0.02 | ∘ |
| No. 51 | 30 | 80 | 30 | 30 | 120 | 30 | 0.5 | 0.03 | ∘ |
| No. 52 | | 110 | | | | | 0.5 | 0.03 | ∘ |
| No. 53 | | 170 | | | | | 0.5 | 0.03 | ∘ |
| No. 54 | 30 | 80 | 30 | 30 | 140 | 30 | 0.6 | 0.02 | ∘ |
| No. 55 | | 110 | | | | | 0.6 | 0.02 | ∘ |
| No. 56 | | 170 | | | | | 0.6 | 0.02 | ∘ |

As shown in Table 2, in all cases of No. 37 to No. 56, the welding speed in the joint terminal end portion was reduced to a welding speed which is not more than 75% of the welding speed in the region in front of the terminal end region (before change), and the current and voltage of each electrode were controlled such that the heat input did not change before and after the change of the welding speed. In addition, in all cases of No. 37 to No. 56, the electrode distance at the joint terminal end portion was changed. As a result, in all cases of No. 37 to No. 56, the value of H/W was 0.3 or more and 0.6 or less at the joint terminal end portion, the strain rate was 0.03 mm/s or less, and no internal crack was observed by the X-ray transmission test, so that a good evaluation result was obtained for all cases.

Therefore, it is found from the results of Test 2 that the crack resistance is improved by reducing the welding speed during the welding of the terminal end region with respect to the present welding.

### (Test 3)

In Test 3, steel plates of different widths and tab plates of different sizes were prepared and the one-side submerged arc welding was performed with changing the electrode distance in the terminal end portion region, and the penetration shape at the joint terminal end portion, the strain rate of the steel plate, and the cracks of the weld metal were evaluated. Table 3 shows the number of electrodes, the current and voltage applied to each electrode, the welding speed, the heat input, the electrode distance, the thickness and the width of the tab plate, and the width of the steel plate, as well as the evaluation results of the penetration shape at the joint terminal end portion, the strain rate of the steel plate, and the cracks of the weld metal in the Examples. In Test 3, except for No. 68-2, the current and voltage values of each electrode, the welding speed, and the heat input after the change of the electrode distance are the same as those before the change. The current and voltage values of each electrode, the welding speed, and the heat input in No. 68-2 after the change of the electrode distance are as follows.

[Welding conditions in No. 68-2 after change of electrode distance]

First electrode: current 1250 A, voltage 34 V

Second electrode: current 1050 A, voltage 37 V

Third electrode: current 800 A, voltage 35 V

Fourth electrode: current 900 A, voltage 36 V

Welding speed: 740 mm/min

Heat input: 11.5 kJ/mm

As also the steel plate 20 subjected to Test 3, a rolled steel material SM400B for welded structures was used, and the thickness of the steel plate was constant at 20 mm.

In addition, as the tab plate 30, a rolled steel material SM400B for welded structures was used, a width of 200 mm meant two plates each having a wide of 100 mm, and the length was 300 mm.

Further, in Test 3, in all cases, the groove of the steel plate 20 and the groove of the tab plate 30 formed by butting the two steel plates 20 and the two tab plates 30 respectively had the same groove shape, and the groove of the steel plate 20 and the groove of the tab plate 30 were subjected to tack welding from at least the terminal end side of the steel plate 20 to the one end portion side of the tab plate 30.

In addition, in all Examples of Test 3, the electrode distance was changed in the range of 2000 mm to 1000 mm in front of the terminal end 29 of the steel plate 20.

TABLE 3

| | | First electrode | | Second electrode | | Third electrode | | Fourth electrode | | Welding | |
|---|---|---|---|---|---|---|---|---|---|---|---|
| | Number of | Current | Voltage | Current | Voltage | Current | Voltage | Current | Voltage | speed | Heat input |
| No. | electrodes | [A] | [V] | [A] | [V] | [A] | [V] | [A] | [V] | [mm/min] | [kJ/mm] |
| No. 57 | 2 | 890 | 31 | 750 | 42 | — | — | — | — | 320 | 11.1 |
| No. 58 | | | | | | | | | | | |
| No. 59 | | | | | | | | | | | |
| No. 60 | | | | | | | | | | | |
| No. 61 | 3 | 1000 | 32 | 750 | 39 | 850 | 41 | — | — | 500 | 11.5 |
| No. 62 | | | | | | | | | | | |
| No. 63 | | | | | | | | | | | |
| No. 64 | | | | | | | | | | | |
| No. 65 | 4 | 1250 | 34 | 1050 | 37 | 850 | 35 | 900 | 36 | 740 | 11.5 |
| No. 66 | | | | | | | | | | | |
| No. 67 | | | | | | | | | | | |
| No. 68 | | | | | | | | | | | |
| No. 68-2 | | 1550 | 35 | 1300 | 41 | 950 | 46 | 1050 | 48 | 1050 | 11.5 |
| No. 69 | 2 | 890 | 31 | 750 | 42 | — | — | — | — | 320 | 11.1 |
| No. 70 | | | | | | | | | | | |
| No. 71 | | | | | | | | | | | |
| No. 72 | 3 | 1000 | 32 | 750 | 39 | 850 | 41 | — | — | 500 | 11.5 |
| No. 73 | | | | | | | | | | | |
| No. 74 | | | | | | | | | | | |
| No. 75 | 4 | 1250 | 34 | 1050 | 37 | 800 | 35 | 900 | 36 | 740 | 11.5 |
| No. 76 | | | | | | | | | | | |
| No. 77 | | | | | | | | | | | |

| | | | | Electrode distance after | | | Shape of tab plate | | Steel | | | |
|---|---|---|---|---|---|---|---|---|---|---|---|---|
| | Electrode distance [mm] | | | change [mm] | | | Tab | Tab | plate | Evaluation | | |
| | First/ | Second/ | Third/ | First/ | Second/ | Third/ | thickness | width | Width | Penetration | Strain rate | |
| No. | second | third | fourth | second | third | fourth | [mm] | [mm] | [mm] | shape | [mm/s] | Cracks |
| No. 57 | 150 | — | — | 80 | — | — | 20 | 200 | 300 | 0.7 | 0.03 | ∘ |
| No. 58 | | | | | | | 40 | 200 | 300 | 0.7 | 0.01 | ∘ |
| No. 59 | | | | | | | 20 | 2000 | 300 | 0.7 | 0.02 | ∘ |
| No. 60 | | | | | | | 20 | 200 | 800 | 0.7 | 0.02 | ∘ |
| No. 61 | 35 | 120 | — | 35 | 80 | — | 20 | 200 | 300 | 0.7 | 0.03 | ∘ |
| No. 62 | | | | | | | 40 | 200 | 300 | 0.7 | 0.01 | ∘ |
| No. 63 | | | | | | | 20 | 2000 | 300 | 0.7 | 0.02 | ∘ |
| No. 64 | | | | | | | 20 | 200 | 800 | 0.7 | 0.02 | ∘ |
| No. 65 | 30 | 170 | 30 | 30 | 140 | 30 | 20 | 200 | 300 | 0.8 | 0.03 | ∘ |
| No. 66 | | | | | | | 40 | 200 | 300 | 0.8 | 0.01 | ∘ |
| No. 67 | | | | | | | 20 | 2000 | 300 | 0.8 | 0.02 | ∘ |
| No. 68 | | | | | | | 20 | 200 | 800 | 0.8 | 0.02 | ∘ |
| No. 68-2 | | | | | | | 20 | 200 | 300 | 0.8 | 0.03 | ∘ |
| No. 69 | 150 | — | — | 80 | — | — | 15 | 200 | 300 | 0.7 | 0.04 | ∘ |
| No. 70 | | | | | | | 20 | 150 | 300 | 0.7 | 0.04 | ∘ |
| No. 71 | | | | | | | 20 | 200 | 250 | 0.7 | 0.04 | ∘ |
| No. 72 | 35 | 120 | — | 35 | 80 | — | 15 | 200 | 300 | 0.7 | 0.05 | ∘ |
| No. 73 | | | | | | | 20 | 150 | 300 | 0.7 | 0.05 | ∘ |
| No. 74 | | | | | | | 20 | 200 | 250 | 0.7 | 0.05 | ∘ |
| No. 75 | 30 | 170 | 30 | 30 | 140 | 30 | 15 | 200 | 300 | 0.8 | 0.06 | ∘ |
| No. 76 | | | | | | | 20 | 150 | 300 | 0.8 | 0.06 | ∘ |
| No. 77 | | | | | | | 20 | 200 | 250 | 0.8 | 0.06 | ∘ |

As shown in Table 3, in all cases of No. 57 to No. 77, the electrode distance at joint terminal end portion was appropriately changed, and the penetration shape at the joint terminal end portion, the strain rate, and the crack evaluation by the X-ray transmission test showed a passed level.

Among these, No. 57 to No. 68 and No. 68-2 satisfy the following: the thickness t2 of the tab plate≥thickness t1 of the steel plate; the width B1 of the two steel plates 20 being 300 mm or more; and the width B2 of the two tab plates 30 satisfying B2≥10×t1 and 100 mm≤B2≤2000 mm, and as described above, the conditions for the tab plate described in the third embodiment are satisfied. In all cases of No. 57 to No. 68 and No. 68-2, the strain rate is reduced to 0.03 mm or less. Therefore, it is found that there is an improvement in cracks of the terminal end in No. 57 to No. 68 and No. 68-2, as compared with No. 69 to No. 77 in which any conditions for the tab plate and the steel plate are not satisfied and other welding conditions are the same.

Further, in Test 3, as shown in No. 78 to No. 89 in Table 4, in the one-side submerged arc welding, in addition to the change of the electrode distance and the use of the tab plate, the welding speed as described in Test 2 was changed halfway. The change position of the electrode distance and the change position of the welding speed are the same positions as in Test 1 and Test 2. In No. 78 to No. 89, the penetration shape was good, the strain rate was low, and an improvement in cracks of the terminal end was confirmed.

TABLE 4

| | | | | |
|---|---|---|---|---|
| Number | First electrode | Second electrode | Third electrode | Fourth electrode |

| | of | Current | Voltage | Current | Voltage | Current | Voltage | Current | Voltage |
|---|---|---|---|---|---|---|---|---|---|
| No. | electrodes | [A] | [V] | [A] | [V] | [A] | [V] | [A] | [V] |
| No. 78 | 2 | 1150 | 33 | 1000 | 45 | — | — | — | — |
| No. 70 | | | | | | | | | |
| No. 80 | | | | | | | | | |
| No. 81 | | | | | | | | | |
| No. 82 | 3 | 1300 | 35 | 1000 | 42 | 1050 | 44 | — | — |
| No. 83 | | | | | | | | | |
| No. 84 | | | | | | | | | |
| No. 85 | | | | | | | | | |
| No. 86 | 4 | 1550 | 35 | 1300 | 41 | 950 | 46 | 1050 | 48 |
| No. 87 | | | | | | | | | |
| No. 88 | | | | | | | | | |
| No. 89 | | | | | | | | | |

| | Welding conditions after change | | | | | | | | | | | |
|---|---|---|---|---|---|---|---|---|---|---|---|---|
| | | | Second | | | | | | | Welding | | Heat input |
| | First electrode | | electrode | | Third electrode | | Fourth electrode | | Welding | speed after | Heat | after |
| | Current | Voltage | Current | Voltage | Current | Voltage | Current | Voltage | speed | change | input | change |
| No. | [A] | [V] | [A] | [V] | [A] | [V] | [A] | [V] | [mm/min | [mm/min | [kJ/mm] | [kJ/mm] |
| No. 78 | 890 | 31 | 750 | 42 | — | — | — | — | 450 | 320 | 11.1 | 11.1 |
| No. 70 | | | | | | | | | | | | |
| No. 80 | | | | | | | | | | | | |
| No. 81 | | | | | | | | | | | | |
| No. 82 | 1000 | 32 | 750 | 39 | 850 | 41 | — | — | 700 | 500 | 11.5 | 11.5 |
| No. 83 | | | | | | | | | | | | |
| No. 84 | | | | | | | | | | | | |
| No. 85 | | | | | | | | | | | | |
| No. 86 | 1250 | 34 | 1050 | 37 | 800 | 35 | 900 | 36 | 1050 | 740 | 11.5 | 11.5 |
| No. 87 | | | | | | | | | | | | |
| No. 88 | | | | | | | | | | | | |
| No. 89 | | | | | | | | | | | | |

| | | | | Electrode distance after | | | Shape of tab plate | | Steel | Evaluation | | |
|---|---|---|---|---|---|---|---|---|---|---|---|---|
| | Electrode distance [mm] | | | change [mm] | | | Tab | Tab | plate | | Strain | |
| | First/ | Second/ | Third/ | First/ | Second/ | Third/ | thickness | width | Width | Penetration | rate | |
| | second | third | fourth | second | third | fourth | [mm] | [mm] | [mm] | shape | [mm/s] | Cracks |
| No. 78 | 150 | — | — | 80 | — | — | 20 | 200 | 300 | 0.5 | 0.01 | ∘ |
| No. 70 | | | | | | | 40 | 200 | 300 | 0.5 | 0.01 | ∘ |
| No. 80 | | | | | | | 20 | 2000 | 300 | 0.5 | 0.01 | ∘ |
| No. 81 | | | | | | | 20 | 200 | 800 | 0.5 | 0.01 | ∘ |
| No. 82 | 35 | 120 | — | 35 | 80 | — | 20 | 200 | 300 | 0.5 | 0.01 | ∘ |
| No. 83 | | | | | | | 40 | 200 | 300 | 0.5 | 0.01 | ∘ |
| No. 84 | | | | | | | 20 | 2000 | 300 | 0.5 | 0.01 | ∘ |
| No. 85 | | | | | | | 20 | 200 | 800 | 0.5 | 0.01 | ∘ |
| No. 86 | 30 | 70 | 30 | 30 | 140 | 30 | 20 | 200 | 300 | 0.6 | 0.01 | ∘ |
| No. 87 | | | | | | | 40 | 200 | 300 | 0.6 | 0.01 | ∘ |
| No. 88 | | | | | | | 20 | 2000 | 300 | 0.6 | 0.01 | ∘ |
| No. 89 | | | | | | | 20 | 200 | 800 | 0.6 | 0.01 | ∘ |

### (Test 4)

Next, in Test 4, the one-side submerged arc welding was performed with changing only the electrode distance in the terminal end portion region, and the penetration shape at the joint terminal end portion, the strain rate of the steel plate, the cracks of the weld metal, and the surface bead appearance were evaluated. Table 5 shows the number of electrodes, the current and voltage applied to each electrode, the welding speed, the heat input, and the electrode distance, as well as the evaluation results of the penetration shape at the joint terminal end portion, the strain rate of the steel plate, the cracks of the weld metal, and the surface bead appearance in the Examples. Regarding the evaluation on the surface bead appearance, the joint after the welding was visually observed, and when there were undercuts, pits, or slag inclusions, it was evaluated as x, and when the above were not recognized, it was evaluated as ∘.

The steel plate 20 subjected to Test 4 was the same as that in Test 1, the tab plate was not used, and tack welding was performed at a pitch of 600 mm on the joint surface 22 of the two steel plates 20. In addition, in all examples of Test 4, the electrode distance was changed in the range of 2000 mm to 1000 mm in front of the terminal end 29 of the steel plate 20.

TABLE 5

| | | | | Second | | | | | | | |
|---|---|---|---|---|---|---|---|---|---|---|---|
| | | First electrode | | electrode | | Third electrode | | Fourth electrode | | Welding | |
| | Number of | Current | Voltage | Current | Voltage | Current | Voltage | Current | Voltage | speed | Heat input |
| No. | electrodes | [A] | [V] | [A] | [V] | [A] | [V] | [A] | [V] | [mm/min] | [kJ/mm] |
| No. 90 | 2 | 890 | 31 | 750 | 42 | — | — | — | — | 320 | 11.1 |
| No. 91 | 3 | 1000 | 32 | 750 | 39 | 850 | 41 | — | — | 500 | 11.5 |
| No. 92 | 4 | 1250 | 34 | 1050 | 37 | 800 | 35 | 900 | 36 | 740 | 11.5 |

| | | | | Electrode distance | | | | | | |
|---|---|---|---|---|---|---|---|---|---|---|
| | Electrode distance [mm] | | | after change [mm] | | | Evaluation | | | |
| | First/ | Second/ | Third/ | First/ | Second/ | Third/ | Penetration | Strain rate | | Surface bead |
| No. | second | third | fourth | second | third | fourth | shape | [mm/s] | Cracks | appearance |
| No. 90 | 70 | — | | 80 | — | — | 0.7 | 0.06 | ∘ | ∘ |
| No. 91 | 35 | 70 | — | 35 | 80 | — | 0.7 | 0.08 | ∘ | ∘ |
| No. 92 | 30 | 130 | 30 | 30 | 140 | 30 | 0.8 | 0.09 | ∘ | ∘ |

It is found from Table 5 that, in all cases of No. 90 to No. 92, the electrode distance at joint terminal end portion was appropriately changed, and thus, the penetration shape at the joint terminal end portion, the strain rate, and the crack evaluation by the X-ray transmission test show a passed level, and the surface bead appearance is good.

The present invention is based on Japanese patent application No. 2017-005871 filed on Jan. 17, 2017, the contents of which are incorporated herein by reference.

### REFERENCE SIGNS LIST

10 One-side submerged arc welding device
11 Base frame
12 Welder (welding unit)
12a Casing
13 Welder beam
15a First electrode
15b Second electrode
15c Third electrode
15d Fourth electrode
16a First power source
16b Second power source
17a First drive mechanism (slider)
17b Second drive mechanism (slider)
18 Control unit
20 Steel plate
22 Joint surface
25 Tack welded portion
25A Tack welded portion
28 Start end
29 Terminal end
30 Tab plate

1. A one-side submerged arc welding method, comprising:
joining two steel plates butted to each other by submerged arc welding from one side using a plurality of electrodes,
wherein during the submerged arc welding, at least one of electrode distances between adjacent electrodes in a terminal end region of the steel plates is changed.

2. The one-side submerged arc welding method according to claim 1, wherein the electrode distance in the terminal end region is shorter than an electrode distance in a region in front of the terminal end region.

3. The one-side submerged arc welding method according to claim 1, wherein the plurality of electrodes include a first electrode, a second electrode and a third electrode, an electrode distance between the first electrode and the second electrode is changed in a range of 10 mm to 250 mm, and an electrode distance between the second electrode and the third electrode is changed in a range of 10 mm to 250 mm.

4. The one-side submerged arc welding method according to claim 1, wherein the plurality of electrodes include a first electrode, a second electrode, a third electrode and a fourth electrode, an electrode distance between the first electrode and the second electrode is changed in a range of 10 mm to 250 mm, an electrode distance between the second electrode and the third electrode is changed in a range of 10 mm to 250 mm, and an electrode distance between the third electrode and the fourth electrode is changed in a range of 10 mm to 250 mm.

5. The one-side submerged arc welding method according to claim 1, wherein welding in the terminal end region is performed at a welding speed which is equal to or less than 75% of a welding speed in a region in front of the terminal end region.

6. The one-side submerged arc welding method according to claim 1, wherein
the submerged arc welding is performed in a state where one end edge of two tab plates has been welded to a terminal end of each of the steel plates,
the following relationship between a thickness of the steel plate and a thickness of the tab plate is satisfied: t2≥t1, wherein t1 is the thickness of the steel plate and t2 is the thickness of the tab plate,
a width B1 of the two steel plates satisfies the following relationship: B1≥300 mm,
a width B2 of the two tab plates satisfies the following relationships: B2≥10×t1 and 100 mm≤B2≤2000 mm,
a groove of the steel plate and a groove of the tab plate, which are formed by abutting the two steel plates and the two tab plates, respectively, have the same groove shape, and
tack welding of the groove of the steel plate and the groove of the tab plate is performed from at least a terminal end portion side of the steel plate to one end portion side of the tab plate.

7. A one-side submerged arc welding device for joining two steel plates butted to each other by submerged arc welding from one side, the one-side submerged arc welding device comprising:
a welding unit which includes a plurality of electrodes and a plurality of power sources which supplies power to the plurality of electrodes, and is movable in a specified direction so as to perform welding from a start end to a terminal end of each of the steel plates by the plurality of electrodes;
a drive mechanism which is disposed in the welding unit and is capable of moving at least one of the plurality of electrodes in an advancing and retracting direction with respect to the welding unit; and
a control unit which controls the drive mechanism to change at least one of electrode distances between adjacent electrodes in a terminal end region of the steel plate during the submerged arc welding.

8. The one-side submerged arc welding method according to claim 2, wherein the plurality of electrodes include a first electrode, a second electrode and a third electrode, an electrode distance between the first electrode and the second electrode is changed in a range of 10 mm to 250 mm, and an electrode distance between the second electrode and the third electrode is changed in a range of 10 mm to 250 mm.

9. The one-side submerged arc welding method according to claim 2, wherein the plurality of electrodes include a first electrode, a second electrode, a third electrode and a fourth electrode, an electrode distance between the first electrode and the second electrode is changed in a range of 10 mm to 250 mm, an electrode distance between the second electrode and the third electrode is changed in a range of 10 mm to 250 mm, and an electrode distance between the third electrode and the fourth electrode is changed in a range of 10 mm to 250 mm.

10. The one-side submerged arc welding method according to claim 2, wherein welding in the terminal end region is performed at a welding speed which is equal to or less than 75% of a welding speed in a region in front of the terminal end region.

11. The one-side submerged arc welding method according to claim 2, wherein
the submerged arc welding is performed in a state where one end edge of two tab plates has been welded to a terminal end of each of the steel plates,
the following relationship between a thickness of the steel plate and a thickness of the tab plate is satisfied: t2≥t1, wherein t1 is the thickness of the steel plate and t2 is the thickness of the tab plate,
a width B1 of the two steel plates satisfies the following relationship: B1≥300 mm,
a width B2 of the two tab plates satisfies the following relationships: B2≥10×t1 and 100 mm≤B2≤2000 mm,
a groove of the steel plate and a groove of the tab plate, which are formed by abutting the two steel plates and the two tab plates, respectively, have the same groove shape, and
tack welding of the groove of the steel plate and the groove of the tab plate is performed from at least a terminal end portion side of the steel plate to one end portion side of the tab plate.
